(19) United States
(12) Patent Application Publication
(10) Pub. No.: US 2025/0219133 A1
(43) Pub. Date: Jul. 3, 2025

(54) SOLID-STATE ELECTROLYTE SYNTHESIS USING A FATTY ACID SURFACTANT

(71) Applicant: Solid Power Operating, Inc., Louisville, CO (US)

(72) Inventors: Sean P. CULVER, Broomfield, CO (US); Bradley J. Ross, Norman, OK (US); Jed Lacoste, Denver, CO (US)

(21) Appl. No.: 19/005,397

(22) Filed: Dec. 30, 2024

Related U.S. Application Data
(60) Provisional application No. 63/616,254, filed on Dec. 29, 2023.

(51) Int. Cl. H01M 10/0562; C01B 25/14

(52) U.S. Cl. CPC H01M 10/0562; C01B 25/14; C01P 2006/40; H01M 2300/008

(57) ABSTRACT

Described herein are processes for producing solid electrolyte materials. The processes include mixing one or more solid electrolyte precursors to form a composite, where the resulting composite includes a fatty acid.

### CROSS-REFERENCE TO RELATED APPLICATION

This application is related to and claims priority under 35 U.S.C. § 119 (e) from U.S. patent application Ser. No. 63/616,254, filed Dec. 29, 2023, titled “Solid-State Electrolyte Synthesis Using a Fatty Acid Surfactant,” the entire contents of which is incorporated herein by reference for all purposes.

### FIELD OF THE DISCLOSURE

The present disclosure is related to processes for making solid electrolyte materials using surfactants that include a fatty acid.

### BACKGROUND AND INTRODUCTION

Advancing battery technologies is paramount to meet the ever-increasing adoption of mobile devices, electric and hybrid vehicles, and other battery powered devices; therefore, the need for battery technologies with improved reliability, capacity (Ah), thermal characteristics, lifetime, and recharge performance has never been greater. Solid-state battery cells utilize a solid electrolyte less likely to develop shorts and fires as compared to liquid electrolyte used in traditional batteries. Thus, solid-state battery cells are typically safer for use in comparison to traditional batteries. However, there remain issues with currently available solid-state battery cells to ensure their wide adoption in the market. Among the issues is that solid-state battery cells can be costly to produce because some raw materials can be expensive, and the manufacturing process complicated. To overcome these challenges, among others, a novel process for synthesizing a solid electrolyte for use in solid-state battery cells has been conceived, which is described herein.

### SUMMARY OF DISCLOSURE

Provided herein is a process for making a solid electrolyte material. The process includes mixing one or more solid electrolyte precursors in one or more solvents and a fatty acid, thereby forming a composite including the fatty acid. In some embodiments, the process may further comprise drying the composite. In some embodiments, the mixing may comprise milling, grinding, or shearing. In some embodiments, the fatty acid is present in the composite at a concentration of about 5 wt % or less. In some embodiments, the fatty acid has a boiling point greater than 300° C. In some embodiments, the one or more solid electrolyte precursors comprise a lithium-containing material, a phosphorus-containing material, or a combination thereof. In some embodiments, the mixing occurs at a temperature from about 20° C. to about 200° C. In some embodiments, the process may further comprise crystallizing the composite, thereby forming a crystallized electrolyte material. In some embodiments, the crystallized electrolyte material has a phosphate content of less than 5 wt %. In some embodiments, the crystallized electrolyte material has a sulfate content of less than 5 wt %.

Further provided herein are compositions made by mixing one or more solid electrolyte precursors in one or more solvents and a fatty acid, thereby forming a composite including the fatty acid. In some embodiments, the composition has a phosphate content of less than 5 wt %. In some embodiments, the composition has a sulfate content of less than 5 wt %.

Further provided herein is a composite comprising a plurality of solid electrolyte material particles, wherein a fatty acid having a boiling point greater than 300° C. is dispersed on a surface of the solid electrolyte material particles.

### BRIEF DESCRIPTION OF THE FIGURES

FIG. 1 shows a flow diagram for processes of the present disclosure.

FIG. 2 shows the ionic conductivity of composites made using the processes of the present disclosure with varying amounts of fatty acid.

FIG. 3 shows a FT-IR spectrum of composites made using the processes of the present disclosure with varying amounts of fatty acid.

### DETAILED DESCRIPTION

Before the present invention is disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/mL.” The endpoint may also be based on the variability allowed by an appropriate regulatory body, such as the FDA, USP, etc.

In this disclosure, the terms “including,” “containing,” and/or “having” are understood to mean comprising, and are open ended terms.

Described herein are processes for preparing solid electrolyte materials. The processes include mixing one or more solid electrolyte precursors in one or more solvents, thereby forming a composite including a fatty acid. The inventors have found that including a fatty acid in the preparation of a solid electrolyte material reduces the formation of phosphate and sulfate impurities, such as lithium phosphate and lithium sulfate. High concentrations of these impurities may reduce ionic conductivity or increase electronic conductivity. Thus, the processes of the present disclosure result in solid electrolytes with improved conductivity.

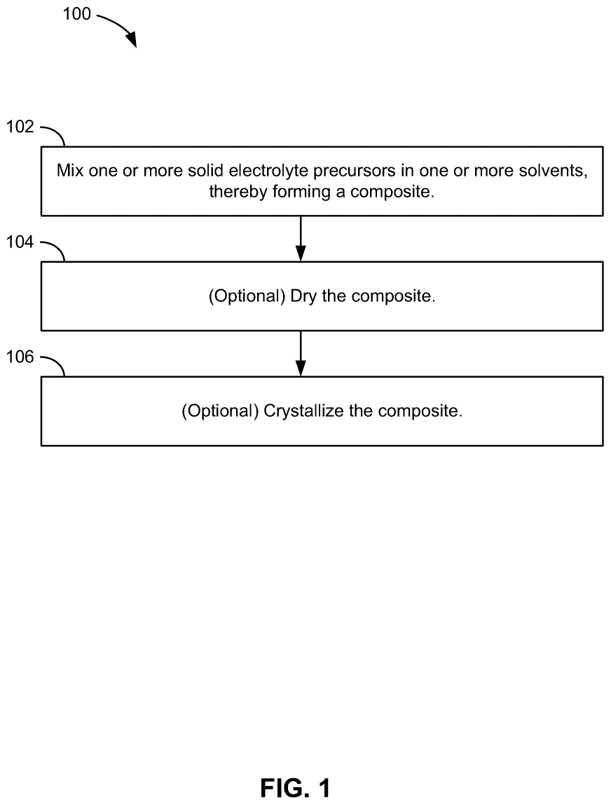

Turning now to FIG. 1, the process 100 of the present disclosure generally includes mixing one or more solid electrolyte precursors in one or more solvents at step 102. The solid electrolyte precursors may include a lithium-containing material, a phosphorus-containing material, or a combination thereof. In some embodiments, the solid electrolyte precursors may also include sulfides.

The mixing in step 102 may be accomplished by methods generally known in the art. In some embodiments, agitators including agitated media mills, twin screw compounders, and other high shear equipment may be used to mix the precursors.

The solvent in the slurry may be selected from but is not limited to one of the following: aprotic hydrocarbons, esters, ethers, or nitriles. In another aspect, the aprotic hydrocarbons may be selected from but are not limited to one of the following: xylenes, toluene, benzene, methyl benzene, hexanes, heptane, octane, alkanes, isoparaffinic hydrocarbons or a combination thereof. In another aspect, the esters may be selected from but are not limited to one of the following: butyl butyrate, isobutyl isobutyrate methyl propionate, ethyl propionate, propyl propionate, butyl propionate, methyl acetate, ethyl acetate, propyl acetate, butyl acetate or a combination thereof. In another aspect, the ethers may be selected from but are not limited to one of the following: diethyl ether, dibutyl ether, benzyl ether or a combination thereof. In another aspect, the nitriles may be selected from but are not limited to one of the following: acetonitrile, propionitrile, butyronitrile, pyrrolidine or a combination thereof.

The amount of solvent present in the slurry may be from about 50% to about 90% by weight of the slurry; in other words, the slurry may have a solids content from about 10% to about 50% by weight of the slurry. In some embodiments, the solvent may be present in the slurry in an amount from about 50% to about 60%, about 50% to about 70%, about 50% to about 80%, about 50% to about 90%, about 60% to about 90%, about 70% to about 90%, or about 80% to about 90% by weight of the slurry. In some embodiments, the slurry may have a solids content from about 20% to about 30% by weight of the slurry.

The temperature of the mixing is controlled such that the temperature is below the boiling point of the solvent used.

A fatty acid is included in the mixture in step 102. The fatty acid acts as a surfactant and improves the rheological properties of the mixture, including the viscosity of the mixture. The fatty acid may include a saturated acid or an unsaturated fatty acid. For example, the fatty acid may include myristoleic acid, palmitoleic acid, sapienic acid, oleic acid, elaidic acid, vaccenic acid, linoleic acid, linoelaidic acid, a-linolenic acid, arachidonic acid, eicosapentaenoic acid, erucic acid, docosahexaenoic acid, caprylic acid, capric acid, lauric acid, myristic acid, palmitic acid, stearic acid, arachidic acid, behenic acid, lignoceric acid, cerotic acid, or any other fatty acid known in the art or combinations thereof.

In some embodiments, the fatty acid may be an un-saturated fatty acid. For example, the fatty acid may include oleic acid, elaidic acid, vaccenic acid, palmitoleic acid, linolenic acid, linoleic acid, or gondoic acid.

Mixing time is not specifically limited as long as it allows for appropriate homogenization and reaction of the precursors to generate the solid electrolyte material. The mixing temperature is also not specifically limited as long as it allows for appropriate mixing and is not so high that a precursor enters the gaseous state. The mixing may be accomplished in an inert atmosphere (e.g., a nitrogen or argon atmosphere), a moisture-free atmosphere (i.e., less than 1% humidity), or an ambient atmosphere.

The mixing may include milling the precursors. The mixture may be milled for a predetermined period of time at a predetermined temperature to achieve a desired particle size. The milling may be accomplished using an attritor mill, an autogenous mill, a ball mill, a planetary ball mill, a buhrstone mill, a pebble mill, a rod mill, a semi-autogenous grinding mill, a tower mill, a vertical shaft impactor mill, or other milling apparatuses known in the art. Preferably, the milling is accomplished in a planetary ball mill or an attritor mill. Milling media may include alumina, zirconia, or other milling media known in the art.

The duration of the milling may be from about 10 minutes to about 48 hours. For example, the duration of the milling may be from about 10 minutes to about 30 minutes, about 10 minutes to about 1 hour, about 10 minutes to about 2 hours, about 10 minutes to about 4 hours, about 10 minutes to about 8 hours, about 10 minutes to about 12 hours, about 10 minutes to about 24 hours, about 10 minutes to about 36 hours, about 10 minutes to about 48hours, about 30 minutes to about 48 hours, about 1 hour to about 48 hours, about 2 hours to about 48 hours, about 4 hours to about 48 hours, about 8 hours to about 48 hours, about 12hours to about 48 hours, or about 24 hours to about 48 hours. As another example, the duration of the milling may be about 10 minutes, 20 minutes, 30 minutes, 40 minutes, 50 minutes, 1 hour, 2 hours, 3 hours, 4 hours, 5 hours, 6 hours, 7 hours, 8 hours, 9 hours, 10 hours, 15 hours, 20 hours, 25 hours, 30 hours, 35 hours, 40 hours, 45 hours, or about 48 hours.

Preferably, the temperature of the milling may be less than the boiling point of the solvent(s) used in the slurry. In some aspects, the milling temperature may be from about 0° C. to about 100° C. For example, the milling temperature may be from about 0° C. to about 25° C., about 0° C. to about 50° C., about 0° C. to about 75° C., about 0° C. to about 100° C., about 25° C. to about 50° C., about 25° C. to about 75° C., about 25° C. to about 100° C., about 50° C. to about 75° C., about 50° C. to about 100° C., or about 75° C. to about 100° C. As another example, the milling temperature may be about 0° C., 10° C., 20° C., 30° C., 40° C., 50° C., 60° C., 70° C., 80° C., 90° C., or about 100° C.

The mixing may include grinding the precursors. The precursors may be ground to reduce the particle size of large particles of precursors for a predetermined time at a predetermined temperature. The grinding may be accomplished by grinding apparatuses generally known in the art, such as a hammer mill, roll crusher, roll press, etc.

The duration of the grinding may be from about 10 minutes to about 48 hours. For example, the duration of the grinding may be from about 10 minutes to about 30 minutes, about 10 minutes to about 1 hour, about 10 minutes to about 2 hours, about 10 minutes to about 4 hours, about 10 minutes to about 8 hours, about 10 minutes to about 12 hours, about 10 minutes to about 24 hours, about 10 minutes to about 36 hours, about 10 minutes to about 48 hours, about 30 minutes to about 48 hours, about 1 hour to about 48 hours, about 2 hours to about 48 hours, about 4 hours to about 48 hours, about 8 hours to about 48 hours, about 12 hours to about 48 hours, or about 24 hours to about 48 hours. As another example, the duration of the grinding may be about 10 minutes, 20 minutes, 30 minutes, 40 minutes, 50minutes, 1 hour, 2 hours, 3 hours, 4 hours, 5 hours, 6 hours, 7 hours, 8 hours, 9 hours, 10hours, 15 hours, 20 hours, 25 hours, 30 hours, 35 hours, 40 hours, 45 hours, or about 48hours.

Preferably, the temperature of the grinding may be less than the boiling point of the solvent(s) used in the slurry. In some aspects, the grinding temperature may be from about 0° C. to about 100° C. For example, the grinding temperature may be from about 0° C. to about 25° C., about 0° C. to about 50° C., about 0° C. to about 75° C., about 0° C. to about 100° C., about 25° C. to about 50° C., about 25° C. to about 75° C., about 25° C. to about 100° C., about 50° C. to about 75° C., about 50° C. to about 100° C., or about 75° C. to about 100° C. As another example, the grinding temperature may be about 0° C., 10° C., 20° C., 30° C., 40° C., 50° C., 60° C., 70° C., 80° C., 90° C., or about 100° C.

The mixing may include shearing the precursors. The precursors may be sheared to reduce the particle size of large particles of precursors for a predetermined time at a predetermined temperature. The shearing may be accomplished using apparatuses generally known in the art, such as a high shear mixer.

The duration of the shearing may be from about 10 minutes to about 48 hours. For example, the duration of the shearing may be from about 10 minutes to about 30 minutes, about 10 minutes to about 1 hour, about 10 minutes to about 2 hours, about 10 minutes to about 4 hours, about 10 minutes to about 8 hours, about 10 minutes to about 12 hours, about 10 minutes to about 24 hours, about 10 minutes to about 36 hours, about 10 minutes to about 48 hours, about 30 minutes to about 48 hours, about 1 hour to about 48 hours, about 2 hours to about 48 hours, about 4 hours to about 48 hours, about 8 hours to about 48 hours, about 12 hours to about 48 hours, or about 24 hours to about 48 hours. As another example, the duration of the shearing may be about 10 minutes, 20 minutes, 30 minutes, 40 minutes, 50minutes, 1 hour, 2 hours, 3 hours, 4 hours, 5 hours, 6 hours, 7 hours, 8 hours, 9 hours, 10hours, 15 hours, 20 hours, 25 hours, 30 hours, 35 hours, 40 hours, 45 hours, or about 48hours.

Preferably, the temperature of the shearing may be less than the boiling point of the solvent(s) used in the slurry. In some aspects, the shearing temperature may be from about 0° C. to about 100° C. For example, the shearing temperature may be from about 0° C. to about 25° C., about 0° C. to about 50° C., about 0° C. to about 75° C., about 0° C. to about 100° C., about 25° C. to about 50° C., about 25° C. to about 75° C., about 25° C. to about 100° C., about 50° C. to about 75° C., about 50° C. to about 100° C., or about 75° C. to about 100° C. As another example, the shearing temperature may be about 0° C., 10° C., 20° C., 30° C., 40° C., 50° C., 60° C., 70° C., 80° C., 90° C., or about 100° C.

Exemplary lithium-containing materials may include one or more of Li₂S, Li₂CO₃, a lithium halide, a lithium pseudohalide, Li₂O, Li₃PO₄, LiBO₂, Li₂B₄O₇, Li₂ZrO₃, LiAIO₂, Li₂TiO₃, LiNbO₃, and Li₂SiO₃, or a mixture thereof. Exemplary lithium halides may include one or more of LiF, LiCl, LiBr, and Lil, while exemplary lithium pseudohalides may include LiNO₃, LiOH, Li₂SO₃, Li₃N, Li₂NH, LiNH₂, LiBF₄, LiBH₄, or a mixture thereof.

Phosphorus-containing materials may include, for example, P₄Sₓ (where x ranges from 3 to 10), P₂S₅, or a combination thereof. In an embodiment, phosphorus sulfide (P₄Sₓ) comprises mixtures of P₄Sₓ, where x ranges from 3 to 10, and may be a combination of P₄S₃, P₄S₄, P₄S₅, P₄S₆, P₄S₇, P₄S₈, P₄S₉, P₄S₁₀, and P₄Sₓ where x is a non-integer. The phosphorus-containing materials may have a low melting temperature. As used herein, a low melting temperature is defined as a melting temperature of less than 300° C., such as 250° C. or less, 200° C. or less, or 150° C. or less.

P₄Sₓ may also be used as the phosphorus-containing material, where x>10. In some embodiments, x may be greater than 40, or 10 <x≤40. In other embodiments, P₄Sₓ is used as a precursor material to form solid electrolyte materials, where 10 <x<35, 10 <x≤30, 10<x≤25, 10<x≤20, 10<x≤15, 10<x≤14, 10<x≤13, 10 <<12, or 10<x≤11. In preferred embodiments, 10<x≤14. Without wishing to be bound by theory, when 10<x≤14, the P₄Sₓis a crystalline-phase material with properties more preferred for forming solid electrolyte materials. When x is greater than about 14, the P₄Sₓ is an amorphous phase material due to the large relative quantities of sulfur.

When the precursors further include P₄Sₓ where x>10, the P₄Sₓ may provide greater than 0% of the phosphorus used in the solid electrolyte material synthesis. For example, the P₄Sₓ, where x>10, may provide greater than 0%, greater than 5%, greater than 10%, greater than 20%, greater than 30%, greater than 40%, greater than 50%, greater than 60%, greater than 70%, greater than 80%, greater than 90%, or greater than 95% of the phosphorus used in the solid electrolyte material synthesis.

In some embodiments, the solid electrolyte precursors may include a sulfur source. Exemplary sulfur sources may include, for example, elemental sulfur, sulfur vapor, a polysulfide, or H₂S gas. Non-limiting examples of polysulfides that may be used as the sulfur source include lithium polysulfide, sodium polysulfide, and potassium polysulfide. In an embodiment, the sulfur source is lithium polysulfide, such as Li₂Sₓ, where x is between 2 and 10. In embodiments where the sulfur source includes sulfur vapor or H₂S gas, the sulfur vapor or H₂S gas may be bubbled through or over the composite as heat is applied and the reaction is taking place. Alternatively, in embodiments where the sulfur source includes elemental sulfur, the elemental sulfur may be added directly to the composite mixture.

The elemental sulfur used herein may be solid sulfur or sulfur vapor (i.e., elemental sulfur heated above its sublimation or boiling point). When the elemental sulfur includes sulfur vapor, the sulfur vapor may be bubbled through the solvent during mixing and/or during milling. Solid elemental sulfur may be added to the mixture or to the solvent as a dry powder. Additionally, the elemental sulfur may be added to the mixture as a solution dissolved in a small portion of the solvent.

The molar ratio of phosphorus to lithium to sulfur (P:Li:S) may be selected such that the reaction produces a desired solid electrolyte material. The molar amount of phosphorus in the molar ratio may be selected from 1 about to about 4, such as from about 1 to about 2, from about 1 to about 3, from about 2 to about 3, from about 2 to about 4, or from about 3 to about 4. In some examples, the molar amount of phosphorus in the molar ratio may be 1, 1.5, 2, 2.5, 3, 3.5, or 4. The molar amount of lithium in the molar ratio may be selected from about 1 to about 9, such as from about 1 to about 3, from about 1 to about 5, from about 1 to about 7, from about 3 to about 5, from about 3 to about 7, from about 3 to about 9, from about 5 to about 7, from about 5 to about 9, or from about 7 to about 9. In some examples, the molar amount of lithium in the molar ratio may be 1, 1.5, 2, 2.5, 3, 3.5, 4, 4.5, 5, 5.5, 6, 6.5, 7, 7.5, 8, 8.5, or 9. The molar amount of sulfur in the molar ratio may be selected from about 3 to about 12, such as from about 3 to about 6, from about 3 to about 9, from about 3 to about 12, from about 6 to about 9, from about 6 to about 12, or from about 9 to about 12. In some examples, the molar amount of sulfur in the molar ratio may be 3, 3.5, 4, 4.5, 5, 5.5, 6, 6.5, 7, 7.5, 8, 8.5, 9, 9.5, 10, 10.5, 11, 11.5, 12, 12.5, or 13. Thus, the molar ratio of phosphorus to lithium to sulfur may be 1-4:1-9:3-12.

The resulting composite may include a solid electrolyte material and the fatty acid. The fatty acid may be present in the composite in an amount of about 5 wt % or less, such as about 4 wt % or less, about 3 wt % or less, about 2 wt % or less, about 1 wt % or less, about 0.5 wt % or less, or about 0.1 wt % or less. In other examples, the fatty acid may be present in the composite in an amount from about 0 wt % to about 5 wt %, such as from about 0 wt % to about 1 wt %, about 0 wt % to about 2 wt %, about 0 wt % to about 3 wt %, about 0 wt % to about 4 wt %, about 0 wt % to about 5 wt %, about 1 wt % to about 5 wt %, about 2 wt % to about 5 wt %, about 3 wt % to about 5 wt %, about 4 wt % to about 5 wt %, about 1 wt % to about 4 wt %, or about 1 wt % to about 3 wt %.

The process described herein may be used to prepare a solid electrolyte material of the formula Li_{(7-y-z)}PS_{(6-y-z)}X_{(y)}W_{(z)} (where X and W are each individually selected from F, Cl, Br, and I, y and z range from 0 to 2, and wherein y+z ranges from 0 to 2. Exemplary solid electrolyte materials prepared by the process described herein may include, for example, Li₃PS₄, Li₄P₂S₆, Li_{5.5}PS_{4.5}Cl_{1.5}, Li_{5.5}PS_{4.5}ClBr_{0.5}, LisPS₄Cl₂, LisPS₄ClBr, and LizP₃S₁₁. In some embodiments, the solid electrolyte material may have the formula Li₆₋ₓS₅₋ₓClₓ where 1≤x≤1.8. The solid electrolyte material may be amorphous, crystalline or an amorphous glass.

The process 100 may continue at step 104 by drying the composite. The drying may be accomplished by evaporation, gravity filtration, vacuum filtration, centrifugation, desiccation, or a combination thereof. The drying may be accomplished under ambient pressure or under vacuum. When drying the composite via evaporation, the composite may be heated to a temperature from about 20° C. to about 250° C.

The process 100 may continue at step 106 by crystallizing the composite to form a crystallized electrolyte material. Systems and apparatuses for crystallizing solid electrolyte materials are generally known in the art. Crystallization may be performed in an inert atmosphere, such as nitrogen or argon. Alternatively, the crystallization may be performed under vacuum pressure. The crystallization may comprise heating the composite at a temperature above the solid electrolyte material's crystallization temperature, e.g. from about 300° C. to about 500° C.

Further provided herein are compositions made by the processes described hereinabove. Primarily, the composition includes the solid electrolyte materials described above in the form of a composite. The solid electrolyte material may be amorphous or crystalline.

The composition may have a sulfate content of about 5% or less. Sulfate content refers to the amount of sulfate compounds (—SO₄) in the composition. For example, the composition may have a sulfate content of about 5% or less, about 4% or less, about 3% or less, about 2% or less, or about 1% or less. As another example, the composition may have a sulfate content in the composition from about 0% to about 5%, such as about 0% to about 1%, about 0% to about 2%, about 0% to about 3%, about 0% to about 4%, about 0% to about 5%, about 1% to about 5%, about 2% to about 5%, about 3% to about 5%, or about 4% to about 5%.

The composition may have a phosphate content of about 5% or less. Phosphate content refers to the amount of phosphate compounds (—PO₄) in the composition. For example, the composition may have a phosphate content of about 5% or less, about 4% or less, about 3% or less, about 2% or less, or about 1% or less. As another example, the composition may have a phosphate content in the composition from about 0% to about 5%, such as about 0% to about 1%, about 0% to about 2%, about 0% to about 3%, about 0% to about 4%, about 0% to about 5%, about 1% to about 5%, about 2% to about 5%, about 3% to about 5%, or about 4% to about 5%.

A fatty acid may be present in the composition in an amount of about 5 wt % or less, such as about 4 wt % or less, about 3 wt % or less, about 2 wt % or less, about 1 wt % or less, about 0.5 wt % or less, or about 0.1 wt % or less. In other examples, the fatty acid may be present in the composition in an amount from about 0 wt % to about 5 wt %, such as from about 0 wt % to about 1 wt %, about 0 wt % to about 2 wt %, about 0 wt % to about 3 wt %, about 0 wt % to about 4 wt %, about 0 wt % to about 5 wt %, about 1 wt % to about 5 wt %, about 2 wt % to about 5 wt %, about 3 wt % to about 5 wt %, about 4 wt % to about 5 wt %, about 1 wt % to about 4 wt %, or about 1 wt % to about 3 wt %.

The fatty acid may be dispersed on the surface of the solid electrolyte material particles in the composition. The dispersion may also include decomposition products from the fatty acid formed at high temperatures during the mixing. This dispersion may form a complete or a partial coating on the particles of the solid electrolyte material in the composition. As shown in the Examples below, the presence of the fatty acid in the final composite does not significantly reduce the ionic conductivity of the composite.

The composite formed by the processes herein by be incorporated into an electrochemical cell, such as a solid-state battery. Specifically, the composite may be incorporated into the anode layer, the cathode layer, or the separator layer of an electrochemical cell.

### EXAMPLES

Examples have been set forth below for the purpose of illustration and to describe certain specific embodiments of the disclosure. However, the scope of the claims is not to be in any way limited by the examples set forth herein. Various changes and modifications to the disclosed embodiments will be apparent to those skilled in the art and such changes and modifications including, without limitation, those relating to the chemical structures, substituents, derivatives, formulations, or methods of the disclosure may be made without departing from the spirit of the disclosure and the scope of the appended claims. Definitions of the variables in the structures in the schemes herein are commensurate with those of corresponding positions in the formulae presented herein.

### Example 1

Li₂S, P₂S₅, and LiCl were mixed together in a molar ratio to produce an Li₆₋ₓPS₅₋ₓClₓ material where 1≤x≤1.8. These materials were mixed in xylenes and a reactive solvent that is classified as an ester to form a slurry. The quantity of solvents and solids used made a mixture of 20 wt % solids. No surfactant was used in this example.

### Example 2

Example 2 was conducted in the same manner as Example 1 except the mixture included 1 wt % of oleic acid.

### Example 3

Example 3 was conducted in the same manner as Example 1 except the mixture included 2 wt % of oleic acid.

### Example 4

Example 4 was conducted in the same manner as Example 1 except the mixture included 1 wt % of oleic acid and the mixture was 25% solids.

### Example 5

Example 5 was conducted in the same manner as Example 1 except the mixture included 2 wt % of oleic acid and the mixture was 30% solids.

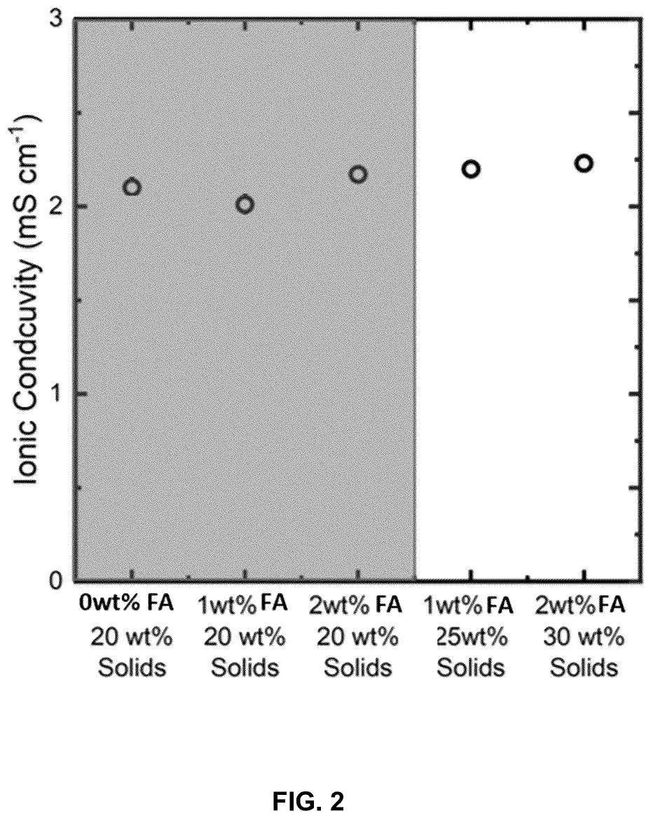

The ionic conductivity of the electrolytes produced in examples 1-5 was tested. The results are shown in FIG. 2. As can be seen in FIG. 2, the inclusion of the fatty acids in the slurry did not significantly reduce the ionic conductivity of the electrolytes.

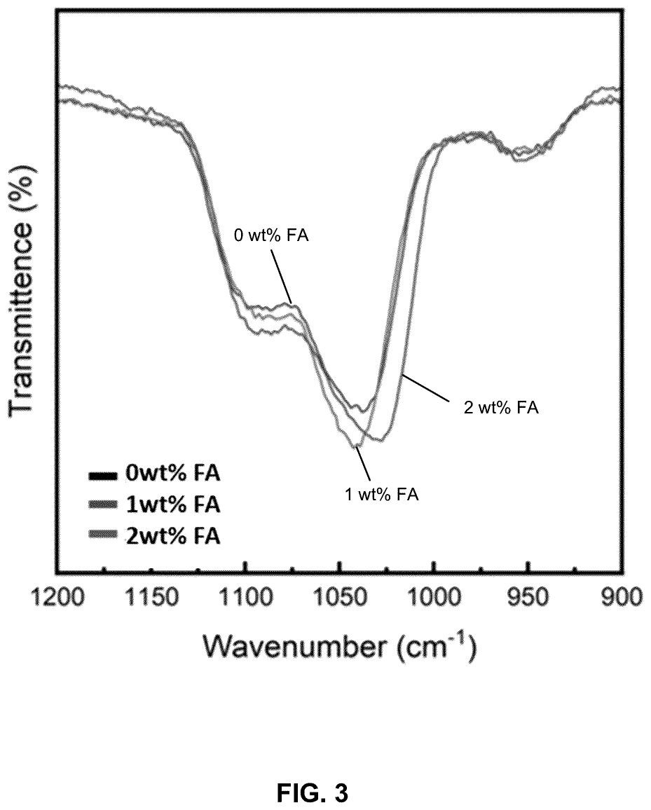

Examples 1-3 were analyzed using FT-IR spectroscopy. The results are shown in FIG. 3. The FT-IR spectrogram shows a signal at about 1050-1075 cm⁻¹, which is understood to correspond to phosphate. As the amount of the fatty acid increased, there was not a substantial increase in the magnitude of the signal at about 1050-1075 cm⁻¹, which suggests that additional phosphate was not created when increasing amounts of fatty acid were used. This is surprising, as it was originally thought that oxygen atoms in the fatty acid would react with lithium to form lithium phosphate, but the FT-IR suggests this did not occur.

What is claimed is:

1. A process for making a solid electrolyte material, the process comprising mixing one or more solid electrolyte precursors in one or more solvents and a fatty acid, thereby forming a composite including the fatty acid.

2. The process of claim 1, wherein the mixing may comprise milling, grinding, or shearing.

3. The process of claim 1, wherein the fatty acid is present in the composite at a concentration of about 5 wt % or less.

4. The process of claim 1, wherein the fatty acid has a boiling point greater than 300° C.

5. The process of claim 1, wherein the one or more solid electrolyte precursors comprise a lithium-containing material, a phosphorus-containing material, or a combination thereof.

6. The process of claim 1, wherein the mixing occurs at a temperature from about 20° C. to about 200° C.

7. The process of claim 1, further comprising drying the composite.

8. The process of claim 1, further comprising crystallizing the composite, thereby forming a crystallized electrolyte material.

9. The process of claim 8, wherein the crystallized electrolyte material has a phosphate content of less than 5 wt %.

10. The process of claim 8, wherein the crystallized electrolyte material has a sulfate content of less than 5 wt %.

11. The process of claim 1, wherein the solid electrolyte material has the formula Li_{(7-y-z)}PS_{(6-y-z)}X_{(y)}W_{(z)}, wherein:
X and W are each individually selected from F, Cl, Br, and I;
y and z each range from 0 to 2; and
wherein y+z ranges from 0 to 2.

12. The process of claim 1, wherein the solid electrolyte material includes LigPS₄, Li₄P₂S₆, Li_{5.5}PS_{4.5}Cl_{1.5}, Li_{5.5}PS_{4.5}ClBr_{0.5}, Li₅PS₄Cl₂, LisPS₄ClBr, Li₇P₃S₁₁, or a combination thereof.

13. The process of claim 1, wherein the solid electrolyte material has the formula Li₆₋ₓPS₅₋ₓClₓ, wherein 1≤x≤1.8.

14. The process of claim 1, wherein the solid electrolyte material particles include Li₅PS₄, Li₄P₂S₆, Li_{5.5}PS_{4.5}Cl_{1.5}, Li_{5.5}PS_{4.5}ClBr_{0.5}, Li₅PS₄Cl₂, Li₅PS₄ClBr, Li₇P₃S₁₁, or a combination thereof.

15. The process of claim 1, wherein the solid electrolyte material particles have the formula Li₆₋ₓPS₅₋ₓClₓ, wherein 1≤x≤1.8.

16. A composition made by the process of claim 1, wherein the composition has a phosphate content of less than 5 wt %.

17. A composition made by the process of claim 1, wherein the composition has a sulfate content of less than 5 wt %.

18. A composite comprising a plurality of solid electrolyte material particles, wherein a fatty acid having a boiling point greater than 300° C. is dispersed on a surface of the solid electrolyte material particles.

19. The composite of claim 18, wherein the solid electrolyte material particles have the formula Li_{(7-y-z)}PS_{(6-y-z)}X_{(y)}W_{(z)}, wherein:
X and W are each individually selected from F, Cl, Br, and I;
y and z each range from 0 to 2; and
wherein y+z ranges from 0 to 2.

20. The composite of claim 18, wherein the solid electrolyte material particles include Li₃PS₄, Li₄P₂S₆, Li_{5.5}PS_{4.5}Cl_{1.5}, Li_{5.5}PS_{4.5}ClBr_{0.5}, Li₅PS₄Cl₂, Li₅PS₄ClBr, Li₇P₃S₁₁, or a combination thereof.
